(19) United States
(12) Patent Application Publication
(10) Pub. No.: US 2008/0229362 A1
(43) Pub. Date: Sep. 18, 2008

(54) METHOD AND SYSTEM FOR PRESENTING INTERACTIVE TELEVISION INTERFACES

(75) Inventors: SCOTT WHITE, AUSTIN, TX (US); GERARD EDWARDS, SAN ANTONIO, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/686,212

(22) Filed: Mar. 14, 2007

(51) Int. Cl. H04N 5/445

(52) U.S. Cl. 725/47

(57) ABSTRACT

A method and system for presenting interactive Television (iTV) interfaces is disclosed. A system that incorporates teachings of the present disclosure may include, for example, an interactive Television (iTV) subsystem having a controller element that presents one among a plurality of selectable user interfaces (UIs) each having a selectable help menu contextually adaptable to its UI. Additional embodiments are disclosed.

### FIELD OF THE DISCLOSURE

The present disclosure relates generally to interactive Television (iTV) systems, and more specifically to a method and system for presenting iTV interfaces.

### BACKGROUND

Interactive Television (iTV) services can often be complicated and difficult for users to understand. The issue is exacerbated by limited space constraints in television-based interfaces, which can force system designers to configure iTV interfaces for readability rather than usability. For example, longer button labels are often foregone in favor of shorter ones. In addition, explanatory text is generally limited. These interfaces result in an iTV experience that can be confusing and unsatisfactory to users.

A need therefore arises for a method and system for presenting interactive television interfaces.

### BRIEF DESCRIPTION OF THE DRAWINGS

FIG. 1 depicts an exemplary embodiment of a communications system;

FIG. 2 depicts an exemplary method operating in the communications system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and system for presenting iTV interfaces.

In a first embodiment of the present disclosure, an interactive Television (iTV) subsystem can have a controller element that presents one among a plurality of selectable user interfaces (UIs) each having a selectable help menu contextually adaptable to its UI.

In a second embodiment of the present disclosure, a computer-readable storage medium can have computer instructions for presenting at a display unit one among a plurality of selectable user interfaces (UIs) each having a selectable help menu contextually adaptable to its UI.

In a third embodiment of the present disclosure, a method can involve an interactive iTV subsystem that presents one among a plurality of selectable UIs associated with an iTV service each having a selectable help menu contextually adaptable to its UI.

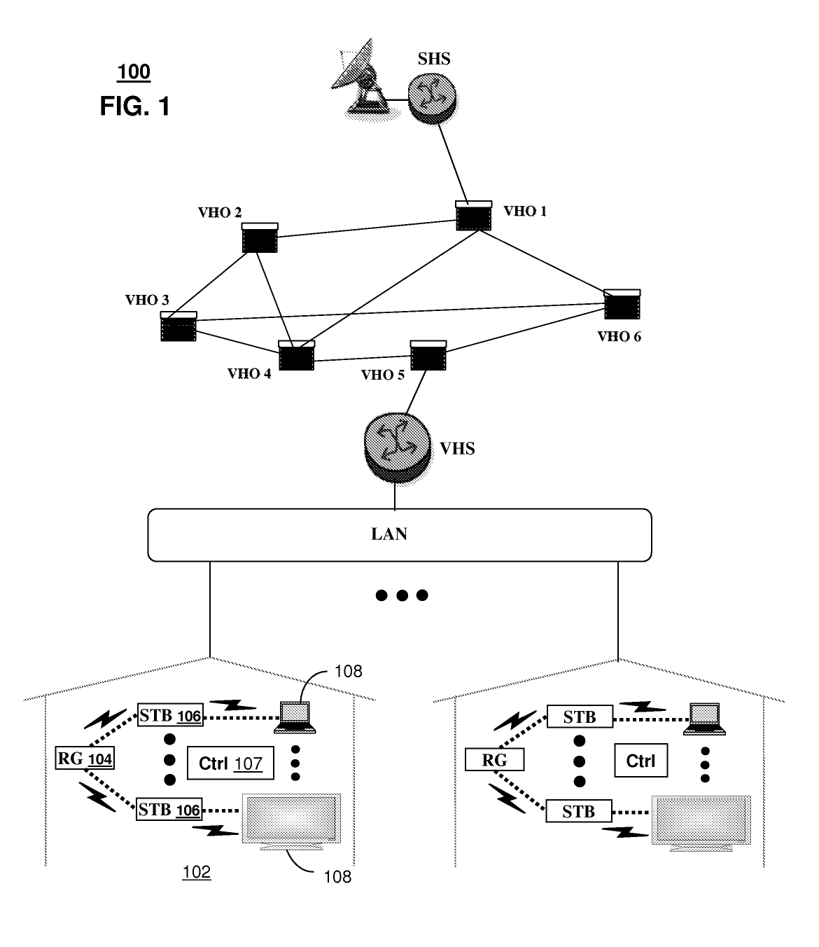

FIG. 1 depicts an exemplary embodiment of an interactive Television (iTV) system 100. As shown in FIG. 1, the system 100 can comprise an IPTV communications system that can be configured to provide iTV services. In a typical IPTV backbone, there is at least one super head office server (SHS) which receives national media programs from satellite and/or media servers from service providers of multimedia broadcast channels. The SHS server forwards IP packets associated with the media content to video head servers (VHS) via a network of video head offices (VHO) according to a common multicast communication method. The VHS then distributes multimedia broadcast programs to commercial and/or residential buildings 102 housing a gateway 104 (e.g., a residential gateway or RG) that distributes broadcast signals to receivers such as Set-Top Boxes (STBs) 106 which in turn presents broadcast selections on display units or media devices 108 such as computers or television units managed in some instances by a media controller 107 (e.g., an infrared or RF remote control). Unicast traffic can also be exchanged between the STBs 106 and the subsystems of the IPTV communication system for presenting iTV services.

Although not shown, the aforementioned IPTV system can also be combined with analog broadcast distributions systems. Accordingly, an iTV subsystem can comprise in whole or in part any of the aforementioned IPTV subsystems, a cable TV subsystem, or an analog or digital STB 106. Said devices can be centralized or decentralized computing devices operating within system 100. Each of said devices in an iTV subsystem can comprise a mass storage system and a controller element. The mass storage system can utilize common storage technologies (e.g., hard disk drives, flash memory, etc.), while the controller element can utilize common computing resources (e.g., a microprocessor, desktop computer, server, etc.) to present and manage interactive user interfaces (UIs) on the media device 108.

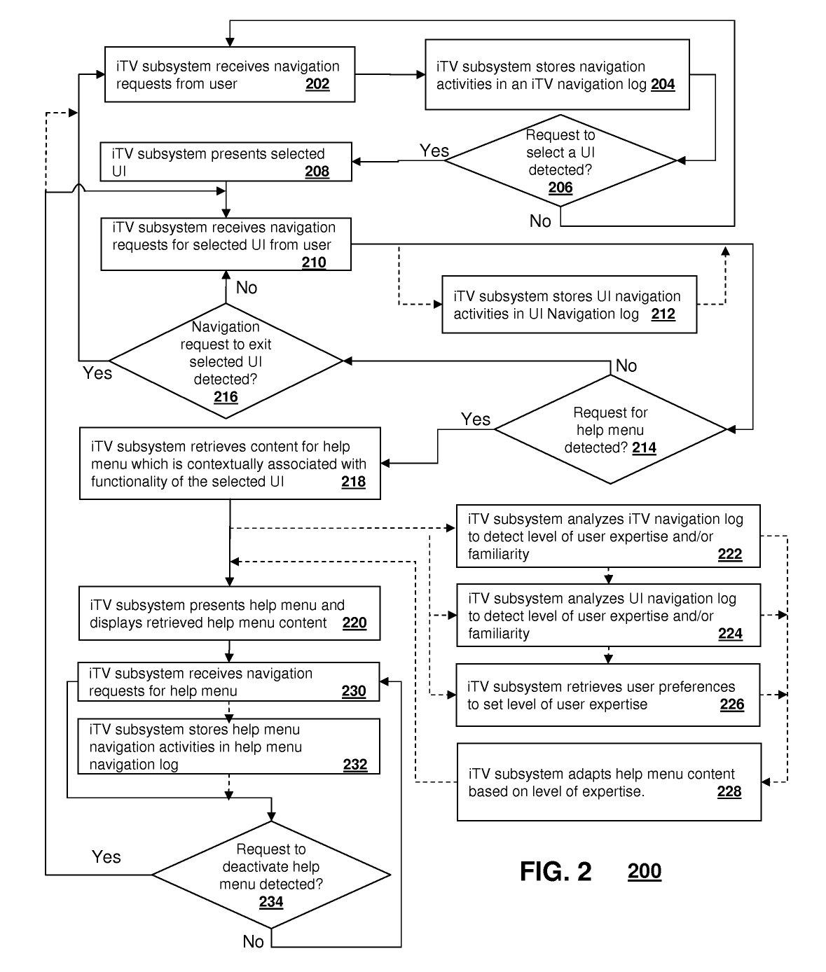

FIG. 2 depicts an exemplary method 200 operating in portions of the iTV system 100. Method 200 can be applied to any of the foregoing iTV subsystems. That is, portions of method 200 can operate in the STB 106 while other portions can operate in other portions such as the VHS. Method 200 begins with step 202 in which the iTV subsystem (e.g., STB 106) receives navigation requests from the media controller 107 or detects navigation activities of a user. For example, an iTV request for an STB 106 can include a request to activate or navigate an electronic program guide (EPG) by selecting a guide button on the media controller 107. In another example, a navigation request can include a request to control or adjust the playback of a video on demand (VoD) program on an STB 106. iTV navigation requests can be received from a media controller 107 or at a navigation interface (e.g., keypad) of the STB 106 or the media device 108.

In response to the iTV subsystem receiving a navigation request or detecting a navigation activity, the iTV subsystem in step 204 can record said navigation requests or activities in an iTV navigation log. The iTV navigation log can be configured to store the navigation requests or activities in several ways. For example, an iTV navigation log can be configured to store iTV navigation requests in a chronological order, thereby providing a record of iTV navigation requests made by the user over time. Alternatively or in combination, the iTV navigation log can track the number of times a type of iTV navigation request is made.

Although the iTV subsystem can store all navigation requests and activities, the iTV navigation log can be configured to highlight navigation requests or activities of particular interest. For instance, the iTV navigation log can be configured to highlight iTV navigation requests or activities related to advanced UI functions. The STB 106 can also log navigation highlight activities associated with VoD or digital video recorder (DVR) functions. Such a configuration can help distinguish between logging of iTV navigation activities pertaining to advanced iTV functions from logging activities for basic iTV functions such as channel navigation.

Referring back to FIG. 2, once the iTV subsystem has stored one or more of the aforementioned embodiments of the iTV navigation log in step 204, the iTV subsystem can proceed to step 206 where it monitors for a navigation request to select a UI associated with an iTV function for presentation on the media device 108. If the iTV subsystem detects no request, the iTV subsystem returns to steps 202 and 204 where it continues to receive and store iTV navigation requests in the iTV navigation log as described earlier. Once the iTV subsystem detects a request to present a UI in step 206, it presents the selected UI in step 208.

In steps 210-216, the iTV subsystem can receive and respond to requests to navigate through the UI presented in step 208. For example, UI navigation can comprise navigating through an EPG or through the UI of a DVR or VoD service presented by the STB 106. In step 210, the iTV subsystem can receive navigation requests for the selected UI from media controller 107 as directed by a user.

Alternatively, or in combination with step 210, the iTV subsystem can be configured in step 212 to store UI navigation requests or activities in a UI navigation log. Similar to the discussion for the iTV navigation log, the UI navigation log can be configured to store only a part of the received UI navigation requests or activities. For instance, the UI navigation log can be configured to store user activities related to specific functions within the UI currently selected. A UI navigation log can be used and stored in several ways. For example, a separate UI navigation log can be created for each UI selected. Alternatively, a single UI navigation log can be used to log UI navigation activities for multiple UIs. Similarly, the iTV navigation log and the UI navigation log can be combined into a single log. In such combined logs, the navigation activities or requests associated with a specific UI may be marked, tagged, or otherwise identified. Such a navigation log configuration allows the iTV subsystem to process a single log file yet still be able to easily identify and retrieve log entries associated with one or more a specific UIs.

Referring back to FIG. 2, once the iTV subsystem has stored one or more of the aforementioned embodiments of the UI navigation log in step 212, the iTV subsystem can proceed to step 214 where it monitors in the selected UI a request to present a help menu. Subsequent to step 214, the iTV subsystem can monitor for a UI navigation request to exit the current UI in step 216. If the iTV subsystem detects no request to present the help menu in step 214 or no request to exit the current UI in step 216, the iTV subsystem can return to step 210 where it can continue to receive UI navigation requests as described earlier. If the iTV subsystem, detects a UI navigation request to exit the UI in step 216, the iTV subsystem can return to step 202, where it continues to monitor for iTV navigation requests.

When the iTV subsystem detects a request to present a help menu in step 214, it proceeds to prepare and present the help menu content according to a number of embodiments presented by steps 218-228. Content for a help menu can include instructions and options for any function of the iTV system 100. To assist an end user, said instructions and options are contextually associated with the selected UI. In addition, the present disclosure can adapt the help menu by dynamically adjusting the content of the help menu and the presentation format according to a detectable end user expertise, familiarity of usage, and/or configurable user preferences.

Prior to presenting the help menu, the iTV subsystem in step 218 can retrieve help menu content that is contextually associated with the functionality of the selected UI. For example, when a user navigates to a VoD UI, instructions can be retrieved related to the user steps involved in downloading and watching a VoD program. Similarly, when a user navigates to a DVR UI, instructions can be retrieved related to the user steps involved in managing DVR functions.

The iTV subsystem can also be configured to selectively retrieve a portion of the content available for a help menu. The retrieved portion can be based on help menu instructions or options that can assist a large majority of users. Such a configuration allows at least a basic help menu to be presented to the average or novice user. Using the retrieved content, the iTV subsystem in step 220 can present the help menu on the media device 108, on a media controller 107 that includes a display (e.g., an LCD), or combinations thereof.

Alternatively, or in combination with step 218, the iTV subsystem can adapt the quantity and complexity of content and options to include in the help menu according to embodiments depicted by steps 222-228. The quantity and/or complexity of help menu instructions can be associated with a detected level of expertise of a user. For example, all or at least a majority of available help menu instructions and options can be presented to a detected expert user to extend advanced capabilities of the iTV system to said user while bypassing novice or intermediate level options. In contrast, content associated with basic functionality of the iTV system can be presented to a detected novice user. Additionally, intermediate expertise levels can also be provided, where a combination of novice and expert help menu instructions or options can be presented. Although expertise levels are referred to on the basis of novice, intermediate, and expert levels, more or less levels and sublevels can be defined for the present disclosure.

Referring back to FIG. 2, the iTV subsystem can analyze the iTV navigation log in step 222 to detect a level of expertise of the user or the user's familiarity with the iTV system. For example, the iTV subsystem can analyze the iTV navigation log to determine a frequency that a user accesses advanced functions in a VoD or DVR system. In another example, the iTV subsystem can be configured to provide a rating or a weight for each type of navigation request or activity stored in a navigation log. Such configurations allow an iTV subsystem to detect an expertise level as a function of the rating, weight, frequency, or any combination thereof, of logged navigation requests or activities. The iTV subsystem can also be configured to analyze a portion of the iTV navigation log. For example, the iTV subsystem can analyze recent activities taking place within one hour intervals. Such a configuration allows the iTV subsystem to more accurately detect an end user's level of expertise on the basis of recent use.

Alternatively, or in combination with step 222, the iTV subsystem in step 224 can detect a level of expertise based on an analysis of the UI navigation log or UI navigation entries in a combined log, as previously discussed. Such a configuration allows the expertise level to be detected on a task by task basis to increase help menu presentation variability. For example, a user may be experienced using VoD functions but not DVR functions. By analyzing the UI navigation log, the iTV subsystem can determine from said log that the end user should be presented the VoD help menu at an expert level while the expertise level for a DVR help menu should be at a novice or intermediate expertise level.

It should be noted that the aforementioned navigation and UI logs can also be analyzed with more sophisticated statistical techniques to recognize end user patterns or behavior. For example, said logs singly or in combination can be analyzed with a common regression analysis technique to detect use patterns and thereby predict end user behavior. As such, a level of expertise can be predicted for each UI of the iTV subsystem with a degree of accuracy that improves as more navigation requests and UI selections are collected in said logs.

In yet another embodiment, a level of expertise can be predetermined by a user preference supplied by the end user. In step 226, the iTV subsystem can be configured to retrieve a user preference for the expertise level. Such a configuration allows the iTV subsystem to adapt the help menu contents without having to analyze the aforementioned logs. Alternatively, a user defined expertise level can be combined with the analysis of steps 222 or 224 to allow the iTV subsystem to further adapt the help menu. For example, the iTV subsystem can be configured to adapt help menu contents when the iTV subsystem determines that the detected expertise level does not match an expertise level specified by the user.

Once the level of expertise is determined in any one of steps 222-226, the iTV subsystem in step 228 can adapt the help menu by adding or removing content such as instructions and/or options according to detected expertise level. For example, longer or larger textual descriptions can be presented to novice users while more abbreviated or limited textual descriptions can be provided to intermediate or expert users. In another example, when the logs have minimal data collected, the iTV subsystem can provide textual descriptions adapted to novice users. Such configurations allow the iTV subsystem to adapt the help menu to the needs of the user. Once the help menu of each UI has been adapted, the iTV system can present it in step 220 as previously discussed.

The help menu presented in step 220 can comprise a separate UI for a user to navigate or can be included as an extension of the selected UI. The iTV subsystem can also configure the components of the system 100 to further enhance the user experience. For example, soft keys can be presented on the media device 108 or media controller 107 to identify specific help menu selections which are directly accessible via the specified soft keys. As with help menu content, the number, type, and display of soft keys and/or direct access options can be associated with an expertise level of the user. For example, more soft keys can be provided for novice users to allow easier access to help menu content while less soft keys can be provided for expert users interested in more specific or detailed help menu content.

Referring back to FIG. 2, once the help menu is presented in step 220, the iTV subsystem in step 230 processes navigation requests associated with the help menu and presents help menu content requested by the user. The iTV subsystem in step 232 can also store help menu navigation requests or activities in a help menu navigation log. The help menu navigation log can be specific to the presented help menu or can be included as a part of the UI navigation log, the iTV navigation log, or other combined log, as previously discussed. Logging navigation requests and activities associated with the help menu allows the iTV subsystem to further adapt the help menu selection to reflect an expertise or familiarity of the user with the presented help menu.

Once the iTV subsystem has stored one or more aforementioned embodiments of the help menu navigation log in step 232, the iTV subsystem can proceed to step 234 where it monitors a navigation request to deactivate the help menu. If the iTV subsystem detects no request to deactivate the help menu in step 234, the iTV subsystem returns to step 230 where it continues to process help menu navigation requests as described earlier. If the iTV subsystem detects a request to deactivate the help menu in step 234, the iTV subsystem returns to the UI and continues to process in step 210 UI navigation requests as described earlier. Alternatively, the iTV subsystem can exit the UI completely and return to step 202 to monitor further iTV navigation requests.

Upon reviewing the aforementioned embodiments, it would be evident to an artisan with ordinary skill in the art that said embodiments can be modified, reduced, or enhanced without departing from the scope and spirit of the claims described below. For example, although the system 100 is discussed in the context of an IPTV communication network, the iTV system can also comprise other communications systems, such as cable TV systems or satellite television systems. In yet other embodiments, the presented help menus can be displayed in the form of tutorials or step-by-step walkthroughs to perform specific actions. Additionally, the embodiments of method 200 can be preformed in whole or in part by any of the iTV subsystems including without limitation the SHS, VHO or VHS, the STB 106, the media controller 107, and media device 108. Also, method 200 can be supplemented with a determination step that identifies which user is utilizing the iTV system, thereby providing a means to store detectable expertise levels on a per user basis. Each user of the iTV system supplies by any suitable means an identification (e.g., unique media controller 107 per user) which can be utilized to selectively identify each end user.

These are but a few examples of modifications that can be applied to the present disclosure without departing from the scope of the claims stated below. Accordingly, the reader is directed to the claims section for a fuller understanding of the breadth and scope of the present disclosure.

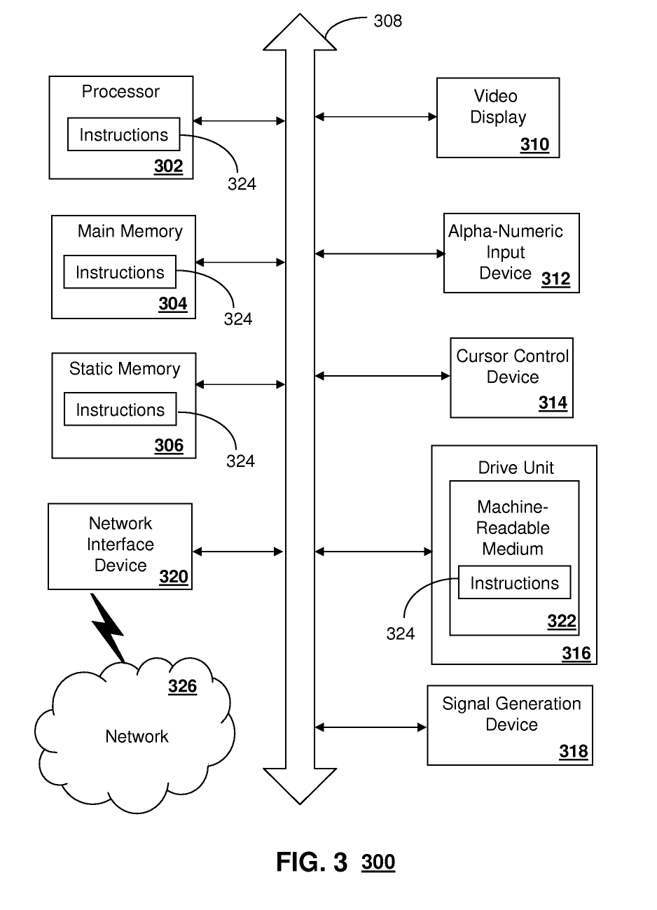

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An interactive Television (iTV) subsystem, comprising a controller element that presents one among a plurality of selectable user interfaces (UIs) each having a selectable help menu contextually adaptable to its UI.

2. The iTV subsystem of claim 1, wherein the controller element:
detects a level of expertise of an end user from a plurality of navigation activities associated with at least one of the plurality of selectable UIs; and
adapts according to said level of expertise the selectable help menu of at least one of the plurality of selectable UIs.

3. The iTV subsystem of claim 2, wherein the controller element detects the level of expertise based on an analysis of a rating assigned to each of the plurality of navigation activities stored in a navigation log.

4. The iTV subsystem of claim 2, wherein the level of expertise detected corresponds to one among a plurality of detectable experience levels.

5. The iTV subsystem of claim 4, wherein the plurality of detectable experience levels comprise one or more levels of a novice user, one or more levels of an intermediate user, and one or more levels of an expert user of the iTV subsystem.

6. The iTV subsystem of claim 5, wherein the controller element adapts the help menu of the at least one of the plurality of selectable UIs to present novice level instructions when the detected level of expertise is a select one of the one or more levels of the novice user.

7. The iTV subsystem of claim 5, wherein the controller element adapts the help menu of the at least one of the plurality of selectable UIs to present intermediate level instructions when the detected level of expertise is a select one of the one or more levels of the intermediate user.

8. The iTV subsystem of claim 5, wherein the controller element adapts the help menu of the at least one of the plurality of selectable UIs to present expert level instructions when the detected level of expertise is a select one of the one or more levels of the expert user.

9. The iTV subsystem of claim 1, wherein the controller element:
receives from a media controller a navigation request;
presents according to the navigation request one of the plurality of selectable UIs with a corresponding selectable help menu.

10. The iTV subsystem of claim 1, wherein each of the help menus comprises one or more selectable soft keys contextually adaptable to its UI.

11. The iTV subsystem of claim 10, wherein the controller element:
detects a level of expertise of an end user from a plurality of navigation activities associated with at least one of the plurality of selectable UIs; and
adapts according to said level of expertise the help menu and its one or more selectable soft keys of at least one of the plurality of selectable UIs.

12. The iTV subsystem of claim 1, wherein the controller element presents in whole or in part at one among a display unit and a media controller that manages operations of the iTV subsystem a select one of the plurality of selectable UIs with its corresponding selectable help menu.

13. The iTV subsystem of claim 1, wherein the help menu of each of the plurality of selectable UIs is pre-configured to contextually supplement functionality presented by each UI.

14. The iTV subsystem of claim 1, wherein the controller element:
detects a familiarity of usage of at least one of the plurality of selectable UIs; and
adapts according to the detected familiarity of usage the selectable help menu of at least one of the plurality of selectable UIs.

15. The iTV subsystem of claim 1, wherein iTV subsystem comprises one among an Internet Protocol Television (IPTV) subsystem, a cable TV subsystem, a satellite TV subsystem, and a Set-Top Box (STB) operating with one among the IPTV, cable TV, and satellite TV subsystems.

16. A computer-readable storage medium, comprising computer instructions for presenting at a display unit one among a plurality of selectable user interfaces (UIs) each having a selectable help menu contextually adaptable to its UI.

17. The storage medium of claim 16, wherein the help menu of each of the plurality of selectable UIs is pre-configured to contextually supplement functionality presented by each UI.

18. The storage medium of claim 16, wherein each of the help menus comprises one or more selectable soft keys contextually adaptable to its UI.

19. The storage medium of claim 17, comprising computer instructions for presenting in whole or in part at one among a display unit and a media controller that a select one of the plurality of selectable UIs with its corresponding selectable help menu and one or more soft keys.

20. The storage medium of claim 16, comprising computer instructions for adapting at least one of the selectable help menus of the plurality of selectable UIs according to a detected level of expertise in utilizing options presented by at least one of the plurality of selectable UIs.

21. A method, comprising an interactive Television (iTV) subsystem that presents one among a plurality of selectable user interfaces (UIs) associated with an iTV service each having a selectable help menu contextually adaptable to its UI.

22. The method of claim 21, comprising adapting the selectable help menu according to a detected level of expertise of an end user utilizing the iTV subsystem.

23. The method of claim 22, comprising detecting the level of expertise of the end user from at least one among a log of navigation requests and a log of UI selections made by the end user.

24. The method of claim 21, comprising:
detecting variable levels of expertise of an end user for each of the selectable UIs; and
adapting the selectable help menu of each UI according to said variable levels of expertise.

25. The method of claim 21, comprising adapting the selectable help menu according to a preference supplied by an end user utilizing the iTV subsystem.

26. The method of claim 21, comprising adapting the selectable help menu according to a detected level of expertise of a select one of a plurality of users utilizing the iTV subsystem.

27. The method of claim 26. comprising:
detecting which of the plurality of users is utilizing the iTV subsystem according to an identification supplied thereby; and
recording the detected level of expertise for each of the detected users.
